(19) United States
(12) Patent Application Publication
(10) Pub. No.: US 2011/0096243 A1
(43) Pub. Date: Apr. 28, 2011

(54) Systems and Methods for Television Receiving System Setup Including Terrestrial Transmitter Locating

(75) Inventor: Steven Casagrande, Castle Rock, CO (US)

(73) Assignee: EchoStar Technologies. L.L.C., Englewood, CO (US)

(21) Appl. No.: 12/605,572

(22) Filed: Oct. 26, 2009

(51) Int. Cl. H04N 5/50

(52) U.S. Cl. 348/731; 348/E05.097

(57) ABSTRACT

A television receiving device may include a tuner configured to selectively tune a television channel from a first plurality of television channels received from a primary television programming source and a second plurality received from a television programming source other than the primary source, wherein the second plurality is received as over-the-air terrestrial television signals. The device may further include a processor configured to set the tuner to receive the second plurality based on location information of the device and location information of a plurality of over-the-air terrestrial antennas. A system for receiving television signals may include a processor configured to set a television receiving device to receive over-the-air television signals from select over-the-air terrestrial antennas, and to determine the select over-the-air terrestrial antennas based on location information of one of the television receiving device and an antenna device and location information of the plurality of over-the-air terrestrial antennas.

### FIELD OF THE INVENTION

The present invention relates generally to television receiving systems, and more particularly to systems and methods for setting up such television receiving systems, including locating terrestrial transmitters.

### BACKGROUND ART

Expansion in television distribution services has led to a variety of television sources, including satellite, cable, Internet and over-the-air (OTA) terrestrial broadcasting. Most television receiving devices are configured to be capable of receiving television broadcasting from a plurality of sources. Typically, a particular receiving device employed may be dedicated to a primary source, while also being capable of receiving one or more additional sources.

For example, a television receiving system may include a set top box (STB) or other television receiving device and an associated satellite dish configured to receive satellite transmissions from a satellite television service provider. The STB may also be configured to receive OTA terrestrial transmissions, either via the satellite dish or a separate antenna. Further, the STB may be configured to receive other data and/or programming transmitted via the Internet, such as through a phone line and/or wirelessly.

In such a television receiving system, the STB and/or the satellite dish typically needs to be set up to receive television broadcast signals based on the location of the system. For example, the satellite dish needs to be oriented properly to receive signals from a satellite associated with the satellite television service provider. Thus, based on the geographic location of the television receiving system, an installer may point the satellite dish as part of an initial setup of the system.

Various systems and methods for setting up television receiving systems are known. For example, U.S. Pat. No. 5,955,988 to Blonstein et al. discloses an approach for establishing the installation location for a satellite-based television system. According to Blonstein et al., the approach is designed to eliminate the need for manual entry of location data and/or to improve the accuracy of defining the installation location.

### BRIEF SUMMARY

When a television receiving system is configured to receive OTA transmissions in addition to the primary source, such as a cable or satellite television service provider, the system may also need to be set up to receive the OTA terrestrial transmissions. However, in such case, set up is not based on knowledge of the location of the system, but is conventionally accomplished by the system scanning for OTA terrestrial transmitters.

In such a conventional approach, the system may scan in all possible directions and at all possible frequencies to identify OTA terrestrial transmitters that provide a sufficient transmission signal strength at the location of the system. This may be relatively time consuming, which may be particularly undesirable for the installer and/or the consumer. For example, the time required for initial setup of the system by a technician is a cost to the service provider and an inconvenience to the consumer, having the technician in their home for an extended period of time. Also, as the system may require a reset after initial installation, either based on a power outage, a software glitch or the like, the time required for setup may inconvenience the consumer by delaying the consumer's enjoyment of the television service during that time. Also, the system may be updated to account for new OTA terrestrial transmitters as they become available by performing a subsequent or even periodic scan for such new OTA terrestrial transmitters.

As such, it may be desirable to provide an improved approach to setup of a television receiving system for receiving OTA terrestrial transmissions. The improved approach may be combined with the setup of the system for receiving transmissions from a primary source, such as cable or satellite, or may be a separate setup, as appropriate or desired. In particular, the improved approach may reduce the time required for the system to be set up initially and/or upon reset of the system. Also, the improved approach may facilitate updating the system to account for changes in the OTA terrestrial transmitters, such as newly established OTA terrestrial transmitters.

Thus, various systems and methods disclosed herein may involve setting up a television receiving device or system for receiving OTA terrestrial television transmissions.

One embodiment may take the form of a television receiving device. The television receiving device may include: at least one tuner configured to selectively tune a television channel from a first plurality of television channels received from a primary television programming source and a second plurality of television channels received from a television programming source other than the primary television programming source, the second plurality of television channels received as over-the-air terrestrial television signals; and a processor configured to set the at least one tuner to receive the second plurality of television channels based on location information of the television receiving device and location information of a plurality of over-the-air terrestrial broadcast antennas.

One embodiment may take the form of a system for receiving television signals. The system may include: at least one antenna device configured to receive over-the-air television signals from over-the-air terrestrial antennas; a television receiving device configured to be set to receive over-the-air television signals from select over-the-air terrestrial antennas via the at least one antenna device; and a processor configured to set the television receiving device to receive over-the-air television signals from the select over-the-air terrestrial antennas, and to determine the select over-the-air terrestrial antennas based on location information of one of the television receiving device and the at least one antenna device and location information of the plurality of over-the-air terrestrial antennas.

Another embodiment may take the form of a method for setup of a device and/or system for receiving over-the-air television signals from over-the-air terrestrial antennas. For example, the method may include: determining location information of the device; determining location information of a plurality of over-the-air terrestrial antennas; determining a subset of the plurality of over-the-air terrestrial antennas based on the determined location information of the device and the determined location information of the plurality of over-the-air terrestrial antennas; and setting the device to receive over-the-air television signals from at least part of the subset of over-the-air terrestrial antennas based at least in part on a strength of over-the-air television signals received at the device from the subset of the plurality of over-the-air terrestrial antennas.

Another embodiment may take the form of a method for updating television receiving systems and/or devices.

### BRIEF DESCRIPTION OF THE FIGURES

FIG. 1 is a schematic representation of a home entertainment system in which embodiments described herein may be employed.

FIG. 2 is a schematic representation of a television receiving device that may be employed in the systems and methods described herein.

FIG. 3 is an example of a table that may be employed by the systems and methods described herein.

FIG. 4 is a flowchart illustrating an example of a method for setup of a television receiving device.

FIG. 5 is a flowchart illustrating an example of a method for updating a television receiving device.

### DETAILED DESCRIPTION

The following describes various embodiments of systems and methods that may be used to setup a television receiving device and/or system. Although specific embodiments may be described in detail, the embodiments disclosed should not be interpreted or otherwise used to restrict the scope of the disclosure provided herein. It should be understood that the following description has broad application, and the discussion of specific embodiments is meant only to be exemplary, and is not intended to represent the only embodiments contemplated and encompassed by this disclosure.

As discussed above, various systems and methods disclosed herein may allow for setup of a television receiving device and/or system. Although the disclosure provided herein is provided in terms of setup of a television receiving device/system, it should be understood that the systems and methods described may also be used to setup and/or update various other devices that are configured to receive transmissions from terrestrial transmitters. For example, it is contemplated that portable devices, such as cell phones and the like, may be set up to receive terrestrial transmissions from OTA antennas or cell towers based on a “home-base” location. Further, as the location of the portable device changes, such as with travel of the user, the portable device may be set up or updated to receive terrestrial transmissions from OTA antennas or cell towers based on the current location.

Various systems and methods described herein may receive installation information that defines a location of the television receiving system. Any suitable method of determining the installation information may be employed. Based on the received installation information, OTA terrestrial antenna information for one or more OTA terrestrial antennas may be determined or identified for the location of the television receiving system. The television receiving system may then perform a focused scan for the determined/identified OTA terrestrial antenna(s) using the OTA terrestrial antenna information.

As such, the television receiving system need not perform a scan for all OTA terrestrial antennas. The television receiving system may instead perform a scan for a subset of OTA terrestrial antennas determined/identified for the particular location of the television receiving system. For example, the television receiving system may perform a scan for the subset of OTA terrestrial antennas based on known transmission frequencies of the determined/identified OTA terrestrial antennas. Additionally, when the television receiving system includes a steerable antenna for receiving OTA terrestrial television signals, the television receiving system may perform the scan for the subset of OTA terrestrial antennas based on computed headings of the determined/identified OTA terrestrial antennas.

The headings of the determined/identified OTA terrestrial antennas may be computed based on the location of the television receiving system and the respective locations of the determined/identified OTA terrestrial antennas. The location of the television receiving system and the locations of the determined/identified OTA terrestrial antennas may be defined in any suitable terms, such as latitude and longitude.

Such an approach may reduce the time needed to set up the television receiving system for receiving OTA terrestrial television signals. For example, the time needed to scan for OTA terrestrial antennas may be reduced by scanning only for the subset of OTA terrestrial antennas. This may be accomplished by scanning only for the known transmission frequencies of the subset of OTA terrestrial antennas. Further, the time needed to scan for OTA terrestrial antennas may be reduced by scanning for each known transmission frequency of the subset of OTA terrestrial antennas at the particular heading of the respective OTA terrestrial antenna of the subset.

Such improved scanning for OTA terrestrial antennas may facilitate an initial setup of the television receiving system to receive OTA terrestrial television signals. Alternatively or additionally, such improved scanning for OTA terrestrial antennas may facilitate a reset of the television receiving system and/or updating the television receiving system to receive OTA terrestrial television signals from new OTA terrestrial antennas and/or OTA terrestrial antenna locations. For example, when a new OTA terrestrial antenna is established or the location of an existing OTA terrestrial antenna is changed, the television receiving system may be updated for receiving OTA terrestrial television signals from the new and/or relocated OTA terrestrial antenna. These and other advantages of the various systems and methods described herein will become apparent from this disclosure.

In general, it may be desirable to setup a television receiving system for receiving OTA terrestrial television signals in addition to setting up the television receiving system for receiving television signals from a primary source, such as cable or satellite. As noted above, there may be a need for setting up the television receiving system for receiving OTA terrestrial television signals independent of any setup for receiving television signals from the primary source. For example, updating the television receiving system for receiving OTA television signals may be desirable after the television receiving system is set up, whereas no updating for the primary source may be needed.

Approaches for setup of a television receiving system for receiving OTA terrestrial television signals may involve novel television receiving devices, novel television receiving antennas, as well as novel systems and novel methods that allow a television receiving device or system to be set up in an efficient manner for receiving OTA terrestrial television signals.

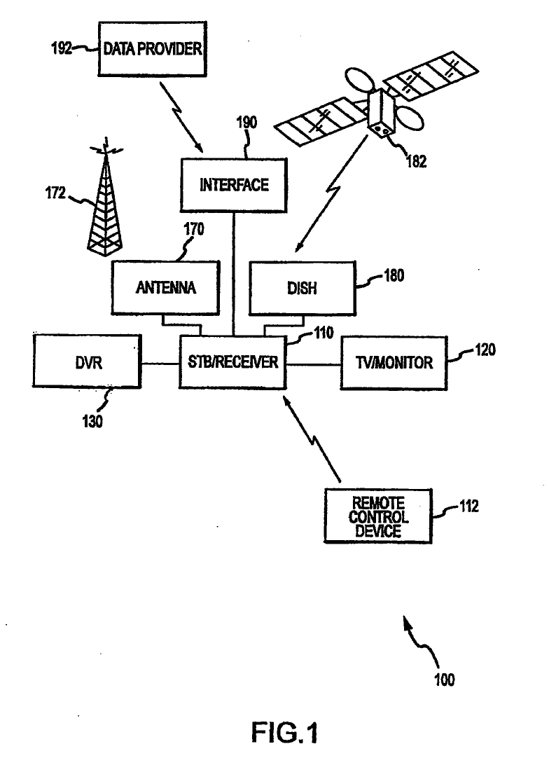

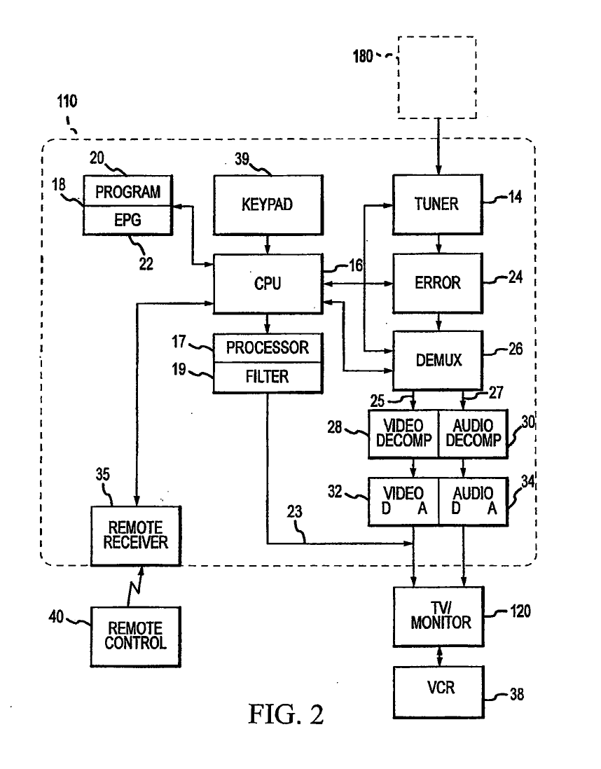

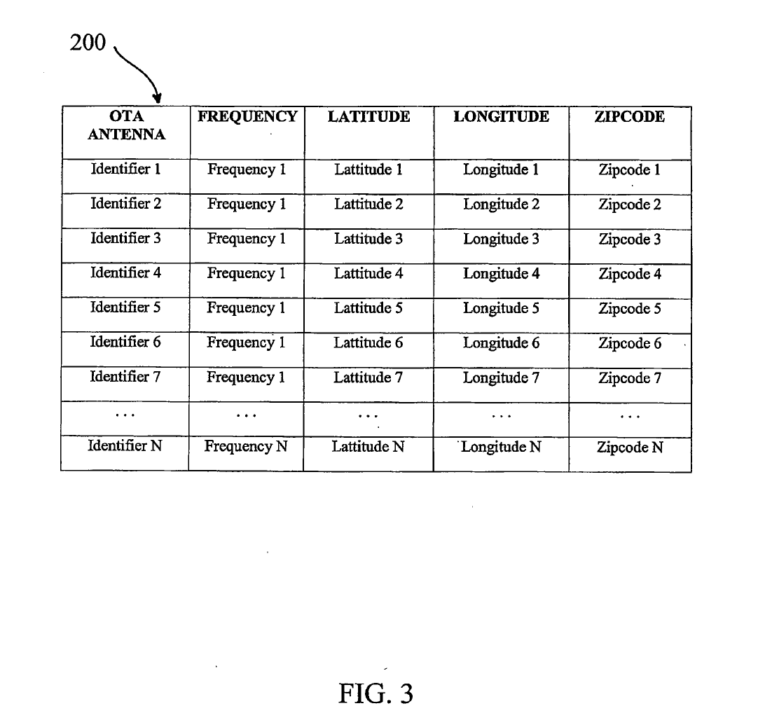

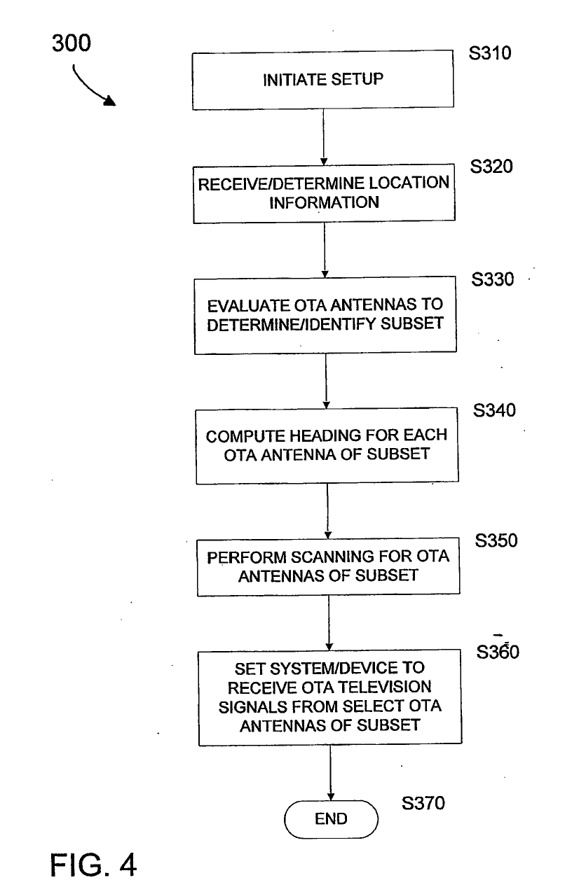

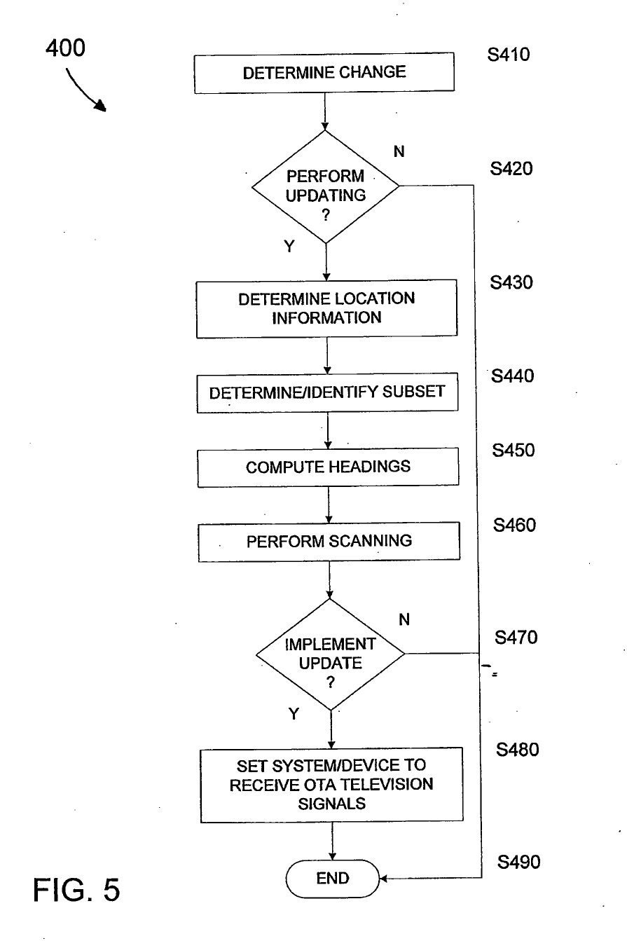

The block diagrams shown in FIGS. 1 and 2, the table shown in FIG. 3 and the flowcharts shown in FIGS. 4 and 5 are for illustration only and are not intended to represent the only possible displays, process flows and system configurations. In particular, it should be understood that process steps may be added, omitted and reordered as may be suitable to a particular application. Also, individual components may be added, omitted, replaced and interrelated as may be suitable to a particular application. All details appurtenant to implementing the exemplary processes and systems that are well understood in the art are omitted for simplicity and clarity.

The systems and methods described herein may be employed, for example, in a home entertainment or television receiving system 100, as illustrated in FIG. 1. Of course, it should be understood that a home entertainment system or television receiving system and the components thereof are merely examples to which the systems and method described herein may be applied. As such, it should be understood that any television receiving system or device that is capable of receiving OTA terrestrial television signals may benefit from or otherwise be employed with such systems and methods.

As illustrated, the television receiving system 100 may include a set top box (STB) or receiver 110. A remote control device 112 may be configured to wirelessly control the STB/receiver 110, as well as the other components of the television receiving system 100, as discussed below. The STB/receiver 110 may be configured to operate as a “hub” or central device for interconnecting various other components of the television receiving system 100. Alternatively, the STB/receiver 110 may be configured to operate independently, with only data being communicated therebetween, for example, for display or recording.

The STB/receiver 110 may be configured to receive inputs from an antenna 170, a satellite dish 180, and/or any other suitable interface 190 (such as a telephone line, coaxial cable, fiber optics, Ethernet, or the like), which are respectively configured to receive OTA television signals via an OTA terrestrial antenna 172, satellite signals from a satellite 182, and appropriate signals from any other suitable interface 192. A basic arrangement of the television receiving system 100 may include the STB/receiver 110, one or more of the antenna 170, the satellite dish 180 or the interface 190, and a television (TV)/monitor 120. Typically, the antenna 170, the satellite dish 180 and/or the interface 190, and the TV/monitor 120 are coupled to the STB/receiver 110 so that television programs or other content via the OTA terrestrial antenna 172, the satellite 182 and/or via a data provider 192 may be communicated to the STB/receiver 110 and, for example, displayed on the television monitor 120, as appropriate or desired.

In such an arrangement, the remote control device 112 may be configured to control the STB/receiver 110 as well as the TV/monitor 120. Although not illustrated, it may be envisioned that the STB/receiver 110 is coupled to a plurality of TV/monitors 120, for example, for multiple room arrangements.

As illustrated in FIG. 1, additional components of the television receiving system 100 may include a digital video recorder (DVR) 130, or any other related device. Although the DVR 130 is illustrated as being coupled to the STB/receiver 110, it should be understood that such a device may be incorporated in the STB/receiver 110. The remote control device 112 may include circuitry configured to control the STB/receiver 110 as well as components, such as the TV/monitor 120 and/or the DVR 130.

The television receiving system 100 may be of any suitable design capable of performing the functions and operations described herein in relation thereto. Thus, it should be understood that the particular implementation illustrated in FIG. 1 is only an example, and that the disclosure provided herein is not limited to such an implementation of a television receiving system 100.

As described above, the television receiving system 100 may require an initial set up for receiving signals from a primary source, such as a satellite television service provider (not shown), and for receiving OTA signals from one or more OTA television broadcast providers (also not shown). It should be understood that the primary source may transmit signals via the satellite 182, and that the OTA television broadcast provider(s) may transmit signals via a respective OTA terrestrial antenna 172.

Initial setup of the television receiving system 100 for receiving signals from the primary source, such as the satellite television service provider, may be performed in any suitable manner. For example, the television receiving system 100 may be set up for receiving signals from the satellite television service provider by methods such as those taught by Blonstein et al. patent.

Initial setup of the television receiving system 100 for receiving OTA signals from one or more OTA television broadcast providers may be performed in conjunction with the initial setup of the television receiving system 100 for receiving signals from the primary source. The location of the television receiving system 100 may be determined in any suitable manner. For example, the manner of determining the location of the television receiving system 100 may be the same as employed for the primary source setup, for example, as taught in the Blonstein et al. patent.

Alternatively, the user and/or the installer may determine and input the location of the television receiving system 100. The primary source setup may not involve a determination of the location of the system 100, may not provide a sufficiently accurate determination, or may not be configured to share the determination with the OTA setup. Thus, although the user and/or the installer may or may not determine and input the location of the television receiving system 100 for primary source setup, it should be understood that the OTA setup may be involve such an operation in various embodiments. For example, the user and/or the installer may input longitude and latitude for the location of the television receiving system 100, or may input a postal zipcode from which the latitude and longitude may be determined. As yet another alternative, a global positioning system (GPS) device may be included in the STB/receiver 110, the antenna 170, or the dish 180. It may be desirable to include the GPS device in the particular component that is to actually receive OTA television transmissions, such as the antenna 170 or the dish 180, so that greater accuracy may be achieved.

To set up the television receiving system 100 for receiving OTA signals from one or more OTA television broadcast providers, the location (e.g., zipcode or latitude and longitude) of the system 100, the STB/receiver 110, the antenna 170 or the dish 180 may be used to determine or identify a subset of OTA terrestrial antennas 172 from which the television receiving system 100 may be capable of receiving OTA television transmissions. For example, the subset of OTA terrestrial antennas 172 may be determined/identified as being associated with the zipcode for the system 100, or as being within a predefined range (distance) of the zipcode or the exact location of the system 100, STB/receiver 110, antenna 170 or dish 180.

In some embodiments, barriers to transmission of OTA television signals may be taken into account to determine the subset of OTA terrestrial antennas 172. For example, when the location of the system 100, STB/receiver 110, antenna 170 or dish 180 is in or near a relatively large city, employ a smaller range (distance) may be employed to account for OTA transmission signals being blocked by taller buildings or other structures. The smaller range (distance) may be employed for all directions or for only directions likely to be affected. For example, when the location of the system 100, STB/receiver 110, antenna 170 or dish 180 is on a north end of the city, a larger range may be employed for north, east and/or west directions, as the range of OTA terrestrial antennas in the south direction may be limited by the city to the south. Similarly, when the location of the system 100, STB/receiver 110, antenna 170 or dish 180 is in or near a naturally occurring barrier, such as the Rocky Mountains, a smaller range may be employed, either in all directions or only those directions from that location that are likely to be affected. It should be understood, however, that man-made and/or naturally occurring barriers may or may not be considered when searching to determine the subset of OTA terrestrial antennas 172.

Once the subset of OTA terrestrial antennas 172 is determined/identified for the particular location of the system 100, STB/receiver 110, antenna 170 or dish 180, the STB/receiver 110 or other part of the system 100 may scan only for frequencies at which the OTA terrestrial antennas 172 of the subset transmit. In other words, scanning for only select frequencies may be employed rather than scanning for all frequencies at which OTA terrestrial antennas 172 may transmit.

Further, when the component that is to actually receive OTA television transmissions, such as the antenna 170 or the dish 180, is steerable or otherwise capable of being selectively pointed in different directions or headings, the scanning may further be limited to scanning for a particular frequency or frequencies at particular directions or headings. For example, the STB/receiver 110 or other part of the system 100 may be configured to determine headings for the OTA terrestrial antennas 172 of the subset based on the location of the system 100, STB/receiver 110, antenna 170 or dish 180 and the location of the OTA terrestrial antennas 172 of the subset. Thus, for each heading that the antenna 170 or dish 180 may be pointed that has one or more associated OTA terrestrial antennas 172 of the subset, the STB/receiver 110 or other part of the system 100 may scan only for the frequencies at which the one or more associated OTA terrestrial antennas 172 transmit.

As noted above, the STB/receiver 110 may be configured to determine or identify the subset of OTA terrestrial antennas 172 from which the television receiving system 100 may be capable of receiving OTA television transmissions, to determine headings for the OTA terrestrial antennas 172 of the subset, and/or to perform scanning for frequencies at which OTA terrestrial antennas 172 may transmit. One example of the STB/receiver 110 is depicted in FIG. 2.

FIG. 2 is a block diagram that shows various components that may be used to implement various features of the present invention. It should be understood that this diagram and the description thereof is intended to provide a general understanding of how the principles described herein may be implemented, and is not exhaustive of implementations that may be envisioned. In particular, it should be understood that the principles described herein may be employed in various transmission systems, not necessarily limited to television broadcast systems.

In the example of a direct broadcast satellite system, packetized transmission according to the MPEG-2 standard may be used as a primary source, although any programming source is contemplated. Signals from the primary source may be received as downlinked signals by the satellite dish 180. Front end processing of the satellite signals may be accomplished by a low noise block converter feed (LNBF) provided in the focal point of the dish. This may involve converting the entire frequency band of the satellite signals to a lower frequency range that may be efficiently transmitted, for example, via coaxial cable to the STB/receiver 110.

The STB/receiver 110 may include a tuner 14, or a plurality of tuners as appropriate or desired, which may select a specific channel from the downlinked signal and feed the selected channel to an error correction and packet synchronization module 24. The error correction and packet synchronization module 24 may output a fully compliant transport stream, which may be directed to a packet demultiplexer 26. Various encoding or formats may be used.

The packet demultiplexer 26 may be an integrated circuit that accepts the packetized, time domain multiplexed data stream of the transport stream and routes the packets to various areas within the STB/receiver 110. Audio may be output as an audio stream 27, which may be accepted by an audio decompresser 30. Video may be output as a video stream 25, which may be accepted by a video decompresser 28. The audio stream 25 and the video stream 27 may be fully compliant audio and video program elementary streams, respectively. In addition to routing packets of data, the packet demultiplexer 26 may also descramble encrypted data, provide various buffering of the formatted data, and handle a program clock reference to keep a local clock synchronized with the clock at the uplink center (e.g., of the satellite television service provider, not shown). Data 29 may be output from the demultiplexer 26 and routed to a central processing unit (CPU) 16, which may assemble the data 29 into an electronic program guide (EPG) 22 stored in a memory or other storage medium 18.

The video decompresser 28 and the audio decompresser 30 may accept one or more video stream 25 and/or audio stream 27, respectively, and decompress them into baseband digital signals. The video stream 25 may then fed to a video digital to analog converter 32 and the audio stream 27 may be fed to a video digital to analog converter 34. The converters 32 and 34 may decode the digital signals and output resulting analog baseband signals to the TV/monitor 120 and/or another device, such as a DVR.

The EPG 22 may comprise a database or otherwise access a database containing information including, for example, names or titles of viewing events (programs), corresponding channel numbers and names, brief descriptions of the programs, start and finish times, and rating and content information related to the events. The central processing unit 16 may execute an EPG program 20, which may take the information stored in the EPG 22 and output a graphic file to a processor 17. The processor 17 may process the graphic file and output a signal, which, after being filtered by a filter 19, may become a video baseband signal 23 that may be combined with the video baseband signal 25 to be displayed on the television/monitor 120.

A user may manipulate and/or provide input to the STB/receiver 110 via a keypad 39 or a remote control device 40. The remote control device 40 may communicate with the CPU 16 by sending an infrared, radio frequency, or other wired or wireless signal to a remote receiver 35, which may transfer commands to the CPU 16.

As discussed above, the STB/receiver 110 may be configured to receive user input of location information of the system 100, STB/receiver 110, antenna 170 or dish 180, such as a postal zipcode or latitude and longitude. Such location information may be stored, for example, in the memory 18 either temporarily or permanently, as appropriate or desired. Also, the location information of the system 100, STB/receiver 110, antenna 170 or dish 180 may be provided to the STB/receiver by an installer, or may be provided automatically from the service provider as part of the setup process, for example, via the satellite 182 and dish 180 or the interface 190, such as a telephone line or the like.

Location information of a plurality of OTA terrestrial antennas (e.g., 172 in FIG. 1) may also be stored in the memory 18. For example, the location information of the plurality of OTA terrestrial antennas may be stored in a lookup table, such as that depicted in FIG. 3, discussed below. The location information of a plurality of OTA terrestrial antennas may be in latitude and longitude, for example, although any suitable location information may be employed, such as a postal zipcode for each of the plurality of OTA terrestrial antennas.

During initial setup of the STB/receiver 110 for receiving OTA television signals, or updating of the STB/receiver 110 as described herein, the CPU 16 may receive the location information of the system 100, STB/receiver 110, antenna 170 or dish 180, either from user input or via another source, such as a GPS device (not shown) that may be included as part of the STB/receiver 110 or the antenna 180, for example. The CPU 16 may use the location information of the system 100, STB/receiver 110, antenna 170 or dish 180 in conjunction with the location information of the plurality of OTA terrestrial antennas stored in the memory 18 to determine or identify a subset of the plurality of OTA terrestrial antennas from which antenna 180 of the STB/receiver 110 may be capable of receiving OTA television signals.

In one embodiment, the location information of a plurality of OTA terrestrial antennas may be in the form of postal zipcodes, with each of the plurality of OTA terrestrial antennas being associated with a particular zipcode based on the location of the particular terrestrial antenna. As noted above, the location information of the system 100, STB/receiver 110, antenna 170 or dish 180 may be in the form of a postal zipcode, latitude and longitude, or otherwise.

In the case of location information of the system 100, STB/receiver 110, antenna 170 or dish 180 in the form of a postal zipcode, the CPU 16 may compare the zipcode for the location of the system 100, STB/receiver 110, antenna 170 or dish 180 with the zipcodes associated with the plurality of OTA terrestrial antennas. The CPU 16 may determine or identify a subset of the plurality of OTA terrestrial antennas as those OTA terrestrial antennas having the matching zipcode associated therewith.

In the case of location information of the system 100, STB/receiver 110, antenna 170 or dish 180 in the form of latitude and longitude, the CPU 16 may convert the received latitude and longitude to a corresponding postal zipcode. Then, the CPU 16 may compare the zipcode for the location of the system 100, STB/receiver 110, antenna 170 or dish 180 with the zipcodes associated with the plurality of OTA terrestrial antennas, and may determine or identify a subset of the plurality of OTA terrestrial antennas as those OTA terrestrial antennas having the matching zipcode associated therewith.

Alternatively, the CPU 16 may determine one or more zipcodes that are within a predetermined distance of the received latitude and longitude. As discussed above, such a determination may take into account various barriers to OTA television transmissions. The CPU 16 may then compare the one or more zipcodes determined for the location of the system 100, STB/receiver 110, antenna 170 or dish 180 with the zipcodes associated with the plurality of OTA terrestrial antennas, and may determine or identify a subset of the plurality of OTA terrestrial antennas as those OTA terrestrial antennas having a zipcode associated therewith that matches one of the one or more determined zipcodes.

In another embodiment, the location information of a plurality of OTA terrestrial antennas may be in the form of latitude and longitude, with each of the plurality of OTA terrestrial antennas being associated with the latitude and longitude of the location of the particular terrestrial antenna. Again, as noted above, the location information of the system 100, STB/receiver 110, antenna 170 or dish 180 may be in the form of a postal zipcode, latitude and longitude, or otherwise.

In the case of location information of the system 100, STB/receiver 110, antenna 170 or dish 180 in the form of a postal zipcode, the CPU 16 may convert the zipcode for the location of the system 100, STB/receiver 110, antenna 170 or dish 180 into a latitude and longitude, such as the latitude and longitude of the geometric center of the received zipcode or another predetermined latitude and longitude associated with the received zipcode. The CPU 16 may calculate a distance between the latitude and longitude associated with the received zipcode and the latitude and longitude of each of the plurality of OTA terrestrial antennas. The CPU 16 may determine or identify a subset of the plurality of OTA terrestrial antennas based on the calculated distances. For example, a predetermined maximum distance from the location of the system 100, STB/receiver 110, antenna 170 or dish 180 may be used to determine or identify the subset, with those OTA terrestrial antennas having a distance from the latitude and longitude associated with the received zipcode that is not more than the maximum distance being part of the subset. As discussed above, the predetermined maximum distance may vary to account for barriers to OTA transmissions, for example, applying a different maximum distance for a particular direction from the location of the system 100, STB/receiver 110, antenna 170 or dish 180 that has such a barrier.

In the case of location information of the system 100, STB/receiver 110, antenna 170 or dish 180 in the form of latitude and longitude, the CPU 16 may directly calculate a distance between the latitude and longitude associated with the received zipcode and the latitude and longitude of each of the plurality of OTA terrestrial antennas. The CPU 16 may then determine or identify a subset of the plurality of OTA terrestrial antennas based on the calculated distances, determining the subset of OTA terrestrial antennas as including those having a distance from the received latitude and longitude that is not more than a predetermined maximum distance, as discussed above.

It should be understood that other forms of the location information of a plurality of OTA terrestrial antennas and/or the location information of the system 100, STB/receiver 110, antenna 170 or dish 180 may be employed without departing from the principles discussed above for determining or identifying the subset of the plurality of OTA terrestrial antennas.

Once the subset of OTA terrestrial antennas is determined or identified, the CPU 16 may proceed to scan for frequencies associated with the OTA terrestrial antennas of the subset. As such, the number of frequencies to be scanned for is reduced as compared to the number of frequencies employed by the plurality of OTA terrestrial antennas. Thus, the scan for the frequencies associated with the OTA terrestrial antennas of the subset may take less time as compared to a scan for all frequencies employed by the plurality of OTA terrestrial antennas.

As discussed above, when the antenna or dish 170, 180 is steerable, the scanning for the frequencies associated with the OTA terrestrial antennas of the subset may be limited to headings from the location of the system 100, STB/receiver 110, antenna 170 or dish 180 to the OTA terrestrial antennas of the subset. For example, the CPU 16 may also compute a heading for each of the OTA terrestrial antennas of the subset using the location information (e.g., postal zipcode, latitude and longitude, or the like) of the system 100, STB/receiver 110, antenna 170 or dish 180 and the location information associated with each of the of the OTA terrestrial antennas of the subset. It should be noted that such computations may be performed after the subset has been determined or identified to minimize computational cost, by not computing headings for any of the plurality of OTA terrestrial antennas not included in the subset.

In such embodiments, the CPU 16 may perform scanning for frequencies associated with the OTA terrestrial antennas of the subset based on the determined headings. For example, with the antenna or dish 170, 180 directed along one of the computed headings, the CPU 16 may perform scanning for only the frequencies associated with the OTA terrestrial antennas of the subset that have that one of the computed headings. The CPU may likewise perform scanning with the antenna or dish 170, 180 directed along each of the other computed headings until scanning has been completed for all headings of the subset of OTA terrestrial antennas.

As discussed above, the scanning may be targeted based on both frequency and heading to minimize the time required to complete the scanning process. The scanning process may involve determining or identifying OTA terrestrial antennas of the subset for which a sufficiently strong transmission signal is received by the antenna or dish 170, 180. Those determined or identified OTA terrestrial antennas of the subset may then be selected and set as OTA terrestrial antennas which the television receiving system is configured to receive, for example, by setting the tuner 14 to receive the frequency of each of the selected OTA terrestrial antennas on a respective channel. Further, when the antenna or dish 170, 180 is steerable, the system may be configured to point the antenna or dish 170, 180 along the heading for the particular OTA terrestrial antenna associated with the frequency currently being tuned in by the tuner 14.

FIG. 3 illustrates an example of a lookup table 200 of location information that may be used in the systems and methods described herein. As illustrated, the lookup table 200 may include location information for a plurality of OTA terrestrial antennas 1-N. Each OTA terrestrial antenna may be denoted by a suitable identifier, such as the transport stream identifier (TSID) of the television channel broadcast by the antenna. In the case of a television channel being broadcast by more than one of the plurality of OTA terrestrial antennas, the identifiers of such antennas may provide differentiation therebetween. As appropriate or desired, the system 100 and/or the STB/receiver 110 may be configured to be set up to receive OTA television transmission signals from one of the OTA terrestrial antennas that broadcast a given television channel, for example, by selecting the OTA terrestrial antenna that broadcasts the given television channel with a strongest signal as received by the antenna 170. Alternatively, the system 100 and/or the STB/receiver 110 may be configured to receive OTA television signals from the other OTA terrestrial antenna(s) that broadcast(s) the given television channel as a backup in case the OTA terrestrial antenna that broadcasts the given television channel with the strongest signal becomes disabled.

It should be understood that the plurality of OTA terrestrial antennas included in the lookup table 200 may vary. For example, it may be unnecessary to include all existing OTA terrestrial antennas in the table for a given television receiving system 100 and/or STB/receiver 110. The lookup table 200 may be limited, for example, to OTA terrestrial antennas that are associated with a particular geographic region, time zone or the like, for which the system 100 and/or STB/receiver 110 is initially intended. This may reduce the memory or storage space needed for the lookup table 200, as well as reduce the number of calculations and/or computations that are performed during the setup of the system 100 for receiving OTA television transmissions.

For example, if a customer receiving a new installation resides in a particular geographic region, time zone or the like, the lookup table 200 stored in the memory 18 of the STB/receiver 110 delivered to the customer may be tailored to that geographic region, time zone or the like. Employing suitably large geographic regions or the like may minimize the number of different lookup tables needed. Further, such geographic regions or the like may take into account barriers to OTA transmissions. For example, the Rocky Mountains may define a region, with areas on either side of the Rocky Mountains defining different regions.

When a customer moves from one region to another, the lookup table 200 may be updated to the new region by any suitable method, such as via transmission of data for the table via a satellite or cable network associated with the STB/receiver 110, or via a backchannel such as a telephone network or the like. Further, the lookup table 200 may be updated to include newly established OTA terrestrial antennas and/or to include location information that has changed for any of the OTA terrestrial antennas already included in the lookup table.

The lookup table 200 may include location information for each of the plurality of OTA terrestrial antennas included in the lookup table. As illustrated, the location information in the lookup table 200 may include the latitude and longitude associated with each of the OTA terrestrial antennas included in the lookup table. Additionally or alternatively, the location information in the lookup table 200 may include the postal zipcode associated with each of the OTA terrestrial antennas included in the lookup table. It should be understood, however, that the lookup table 200 may include location information in any suitable form other than the latitude and longitude and the zipcode, either in addition thereto or instead thereof. Further, the lookup table 200 may include the broadcast frequency associated with each of the OTA terrestrial antennas included in the lookup table, that is, the frequency at which the particular OTA terrestrial antenna broadcasts its signal. It should be understood that knowledge of the frequency may be helpful for the scanning and/or tuning process.

It should be understood that a plurality of lookup tables may be employed. For example, the lookup table 200 may include postal zipcodes, but not latitude and longitude associated with each of the OTA terrestrial antennas included in the lookup table. A secondary lookup table (not shown) may match postal zipcodes with corresponding latitude and longitude values. Thus, when only the postal zipcode is known by the system, whether input by the user, technician or otherwise determined, the system may determine the corresponding latitude and longitude.

Embodiments of the system 100 and/or the STB/receiver 110 may be configured to perform a method 300 as illustrated in FIG. 4. The process may begin at S310, where a setup mode may be initiated. The setup mode may be initiated by a user or an installer employing the remote control device 112 and/or the keypad 39 of the STB/receiver 110. Alternatively, the setup mode may be initiated by the service provider, such as via the satellite 182 and dish 180 or the interface 190, such as a telephone line or the like. The setup mode may involve setup of the system 100 and/or the STB/receiver 110 both to receive television transmissions from a primary source, such as a satellite television provider, and to receive OTA television transmissions from OTA terrestrial antennas. However, the illustrative method 300 does not include setup of the system 100 and/or the STB/receiver 110 to receive television transmissions from the primary source, as this may be accomplished by any known method.

Once in the setup mode, the process may continue to S320, where location information of the system 100, STB/receiver 110, or antenna 170 may be received by the STB/receiver 110 from any suitable source. As discussed above, the location information of the system 100, STB/receiver 110, or antenna 170 may be received from input by a user or an installer, or from the service provider based on the customer's address, for example. Additional or alternatively, the location information of the system 100, STB/receiver 110, or antenna 170 may already be known from the setup of the system 100 and/or the STB/receiver 110 to receive television transmissions from the primary source. In any case, this location information may be temporarily or permanently stored in the memory 18 of the STB/receiver 110 for use by the CPU 16.

Once the location information of the system 100, STB/receiver 110, or antenna 170 has been received, the process may continue to S330, where a plurality of OTA terrestrial antennas may be evaluated to determine or identify a subset of the plurality of OTA terrestrial antennas. As discussed above, this may involve comparing the location information of the system 100, STB/receiver 110, or antenna 170 with the location information of the plurality of OTA terrestrial antennas. In such case, the CPU 16 may perform such comparing to determine which of the plurality of OTA terrestrial antennas have location information that matches the location information of the system 100, STB/receiver 110, or antenna 170.

Alternatively, the plurality of OTA terrestrial antennas may be evaluated to determine a subset of the plurality of OTA terrestrial antennas by calculating a distance between the system 100, STB/receiver 110, or antenna 170 and each of the plurality of OTA terrestrial antennas. The calculated distances may be used to determine or identify which of the plurality of OTA terrestrial antennas are part of the subset. For example, as discussed above, each of the distances may be compared to a predetermined maximum distance, with only the OTA terrestrial antennas having calculated distances that are within the predetermined maximum distance being included in the subset.

Once the subset of OTA terrestrial antennas has been determined, the process may optionally proceed to S340, where a heading may be computed for each of the OTA terrestrial antennas of the subset. As discussed above, this operation may be performed when the antenna 170 is configured to receive OTA television signals is steerable.

The process may then proceed to S350, where the system 100 or the STB/receiver 110 performs scanning for the OTA terrestrial antennas of the subset. As discussed above, such scanning may involve scanning for the frequencies at which the OTA terrestrial antennas included in the subset transmit or broadcast television signals. Additionally, when the antenna 170 configured to receive OTA television signals is steerable and the headings are computed at S340, such scanning may involve scanning for the particular frequencies of the OTA terrestrial antennas included in the subset along the particular headings.

Once the scanning is performed, the process may continue to S360, where the system 100 or the STB/receiver 110 may be set to receive OTA television signals from select ones of the OTA terrestrial antennas of the subset. The select ones of the OTA terrestrial antennas may be determined based on the strength of the signals received by the antenna 170 during the scanning at S350. For example, a threshold signal strength may be determined that is sufficient to maintain reliable reception of an OTA terrestrial television signal. As such, only the OTA terrestrial antennas of the subset that meet or exceed this threshold signal strength during scanning may be included in the select ones from which the system 100 or the STB/receiver 110 is set to receive OTA television signals.

Once the system 100 or the STB/receiver 110 has been set to receive OTA television signals from the select ones of the OTA terrestrial antennas of the subset, the process may continue to S370, where the process may end.

It should be understood that the foregoing method 300 is only an example, and that modifications may be made without altering the general principles. For example, it should be understood that any of the approaches discussed herein may be employed to carry out a method for setting up a system and/or device for receiving OTA television signal from one or more OTA terrestrial antennas.

In view of the foregoing, it should be understood that, in general, the method of setup may be based on the location information of the system 100, STB/receiver 110, or antenna 170 and the location information of the plurality of OTA terrestrial antennas. As described herein, the method of setup may avoid scanning for all headings and/or all frequencies of the plurality of OTA terrestrial antennas by determining or identifying a subset of the plurality of OTA terrestrial antennas. It should be understood that this approach may be extended, as appropriate or desired, to allow updating of the system 100 and/or the STB/receiver 110 to account for changes in location of the system 100, STB/receiver 110, or antenna 170, changes in the location of one or more of the plurality of OTA terrestrial antennas, and/or establishment of one or more new OTA terrestrial antennas potentially within range for reception by the antenna 170 of the system 100.

Embodiments of the system 100 and/or the STB/receiver 110 may be configured to perform a method 400 for updating the system 100 and/or the STB/receiver 110 as illustrated in FIG. 5. The process may begin at S410, where a change in reception possibilities of OTA television signals by the system 100 and/or the STB/receiver 110 is determined. The change may be determined by the user or the installer, or may be determined by the service provider. For example, the user, the installer and/or the service provider may initiate updating based on installation of the system 100 and/or the STB/receiver 110 at a different location, as when the customer has changed residence. Also, the user and/or the service provider may initiate updating when aware of changes in OTA terrestrial antennas from which the system 100 and/or the STB/receiver 110 may receive OTA television signals.

In case of the service provider determining a change in reception possibilities or otherwise initiating updating of the system 100 and/or the STB/receiver 110, the updating may be performed without user interaction and without interruption of service of television programming from either the primary source or the OTA terrestrial antennas from which the system 100 and/or the STB/receiver 110 is already set to receive OTA television signals. For example, the updating process may be performed without the user even being aware that updating is occurring. Alternatively, the user may be notified, either to begin the updating process or to implement the update to reset the system 100 and/or the STB/receiver 110 to include the changes.

Thus, the process may continue to S420, where the user is asked whether or not to perform updating. Based on receipt of a user reply or the lack thereof, a determination may be made at S420 whether or not to continue the process. If not, the process may jump to S490, where the process may end.

Otherwise, the process may continue to S430, where location information of the system 100, STB/receiver 110, or antenna 170 may be received by the STB/receiver 110. S430 may be bypassed, for example, where the location information of the system 100, STB/receiver 110, or antenna 170 has not changed. For example, the process may or may not include a query to the user or installer asking whether or not such location information has changed. If not, the process may continue using the location information of the system 100, STB/receiver 110, or antenna 170 as stored in the memory 18 of the STB/receiver 110, for example.

The process may continue to S440, where a plurality of OTA terrestrial antennas may be evaluated to determine or identify a subset of the plurality of OTA terrestrial antennas. The plurality of OTA terrestrial antennas evaluated may be the same described above for initial setup, such as when the location information of the system 100, STB/receiver 110, or antenna 170 has changed. Alternatively, the plurality of OTA terrestrial antennas evaluated may only include the OTA terrestrial antennas for which a change has occurred, such as in location and/or frequency, and/or newly established OTA terrestrial antennas. Any of the approaches discussed above with respect to the method 300 may be employed for determining or identifying the subset.

As above, once the subset of OTA terrestrial antennas has been determined, the process may optionally proceed to S450, where a heading may be computed for each of the OTA terrestrial antennas of the subset. As discussed above, this operation may be performed when the antenna 170 configured to receive OTA television signals is steerable.

The process may then proceed to S460, where the system 100 or the STB/receiver 110 performs scanning for the OTA terrestrial antennas of the subset. As discussed above, such scanning may involve scanning for the frequencies at which the OTA terrestrial antennas included in the subset transmit or broadcast television signals, with or without headings taken into account.

Once the scanning is performed, the process may continue to S470, where optionally the user is asked whether or not implement an update. This may be desirable where the process may be performed without service interruption up to this point, but not to the point of setting the system 100 or the STB/receiver 110 to receive OTA television signals from select ones of the OTA terrestrial antennas of the subset, at S480. Implementing an update may temporarily interrupt service, for example, when OTA broadcast television signals are being viewed, and thus a user may wish to postpone or decline an update. Based on receipt of a user reply or the lack thereof, a determination may be made at S470 whether or not to continue the process. If not, the process may jump to S490, where the process may end.

Otherwise, the process may continue to S480, where the system 100 or the STB/receiver 110 may be set to receive OTA television signals from the select ones of the OTA terrestrial antennas of the subset. The select ones of the OTA terrestrial antennas may be determined as discussed above.

Once the system 100 or the STB/receiver 110 has been updated by setting at S480, the process may continue to S490, where the process may end.

It should be understood that the flowchart of FIG. 5 is only an example, and that other methods, whether by addition of operations, omission of operations, and/or reordering of operations, may be envisioned. As such, it should be understood that any suitable flow of operations may be determined as appropriate or desired for a given implementation of updating the setup of a system or device for receiving OTA television signals from OTA terrestrial antennas based on the description provided herein.

The foregoing merely illustrates the principles of the invention. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the invention and are thus within the spirit and scope of the present invention. From the above description and drawings, it will be understood by those of ordinary skill in the art that the particular embodiments shown and described are for purposes of illustration only and are not intended to limit the scope of the present invention. References to details of particular embodiments are not intended to limit the scope of the invention.

What is claimed is:

1. A television receiving device, comprising:
at least one tuner configured to selectively tune a television channel from a first plurality of television channels received from a primary television programming source and a second plurality of television channels received from a television programming source other than the primary television programming source, the second plurality of television channels received as over-the-air terrestrial television signals; and
a processor configured to set the at least one tuner to receive the second plurality of television channels based on location information of the television receiving device and location information of a plurality of over-the-air terrestrial antennas.

2. The device of claim 1, wherein the processor is configured to select a subset of the plurality of over-the-air terrestrial antennas based on the location information of the television receiving device and the location information of the plurality of over-the-air terrestrial antennas, and to scan only for frequencies at which over-the-air terrestrial antennas of the subset transmit over-the-air terrestrial television signals.

3. The device of claim 2, wherein scanning for the frequencies yields a signal strength associated with each of the over-the-air terrestrial antennas of the subset, and the processor is configured to set the at least one tuner to receive the second plurality of television channels from over-the-air terrestrial antennas of the subset for which the associated signal strength is not less than a predetermined threshold.

4. The device of claim 2, wherein the processor is configured to determine a heading for each of the over-the-air terrestrial antennas of the subset, and to scan for the frequency of each of the over-the-air terrestrial antennas of the subset only along the determined heading for the respective over-the-air terrestrial antennas of the subset.

5. The device of claim 2, wherein the processor is configured to select the subset of the plurality of over-the-air terrestrial antennas based on a distance between the television receiving device and each of the plurality of over-the-air terrestrial antennas.

6. The device of claim 2, wherein the location information of the television receiving device comprises a postal zipcode corresponding to a location of the television receiving device, the location information of the plurality of over-the-air terrestrial antennas comprises, for each respective over-the-air terrestrial antenna of the plurality, a postal zipcode corresponding to a location of the respective over-the-air terrestrial antenna, and the processor is configured to select the subset of the plurality of over-the-air terrestrial antennas based on a distance between a predetermined location associated with the postal zipcode corresponding to the location of the television receiving device and a predetermined location associated with the postal zipcode corresponding to the location of the respective over-the-air terrestrial antenna for each of the plurality of over-the-air terrestrial antennas.

7. The device of claim 2, wherein the location information of the television receiving device comprises a latitude and a longitude corresponding to a location of the television receiving device, the location information of the plurality of over-the-air terrestrial antennas comprises, for each respective over-the-air terrestrial antenna of the plurality, a latitude and a longitude corresponding to a location of the respective over-the-air terrestrial antenna, and the processor is configured to select the subset of the plurality of over-the-air terrestrial antennas based on a distance between the latitude and longitude corresponding to the location of the television receiving device and the latitude and longitude corresponding to the location of the respective over-the-air terrestrial antenna for each of the plurality of over-the-air terrestrial antennas.

8. The device of claim 7, wherein the processor is configured to receive the location information of the television receiving device as a street address defining the location of the television receiving device, and to convert the street address into the latitude and longitude corresponding to the location of the television receiving device.

9. A system for receiving television signals, comprising:
at least one antenna device configured to receive over-the-air television signals from over-the-air terrestrial antennas;
a television receiving device configured to be set to receive over-the-air television signals from select over-the-air terrestrial antennas via the at least one antenna device; and
a processor configured to set the television receiving device to receive over-the-air television signals from the select over-the-air terrestrial antennas, and to determine the select over-the-air terrestrial antennas based on location information of one of the television receiving device and the at least one antenna device and location information of the plurality of over-the-air terrestrial antennas.

10. The system of claim 9, wherein the processor is configured to determine the select over-the-air terrestrial antennas as at least part of a subset of the plurality of over-the-air terrestrial antennas based on the location information of the one of the television receiving device and the at least one antenna device and the location information of the plurality of over-the-air terrestrial antennas, and to scan only for frequencies at which over-the-air terrestrial antennas of the subset transmit over-the-air terrestrial television signals.

11. The system of claim 10, wherein scanning for the frequencies yields a signal strength associated with each of the over-the-air terrestrial antennas of the subset, and the processor is configured to determine the select over-the-air terrestrial antennas as the over-the-air terrestrial antennas of the subset for which the associated signal strength is not less than a predetermined threshold.

12. The system of claim 10, wherein at least one of the processor and the television receiving device is configured to steer the at least one antenna device, the processor is configured to determine a heading for each of the over-the-air terrestrial antennas of the subset, and the processor is configured to scan for the frequency of each of the over-the-air terrestrial antennas of the subset only along the determined heading for the respective over-the-air terrestrial antennas of the subset.

13. The system of claim 10, wherein the processor is configured to determine the select over-the-air terrestrial antennas as at least part of a subset of the plurality of over-the-air terrestrial antennas based on a distance between the one of the television receiving device and the at least one antenna device and each of the plurality of over-the-air terrestrial antennas.

14. The system of claim 10, wherein the location information of the one of the television receiving device and the at least one antenna device comprises a postal zipcode corresponding to a location of the one of the television receiving device and the at least one antenna device, the location information of the plurality of over-the-air terrestrial antennas comprises, for each respective over-the-air terrestrial antenna of the plurality, a postal zipcode corresponding to a location of the respective over-the-air terrestrial antenna, and the processor is configured to determine the select over-the-air terrestrial antennas of the plurality of over-the-air terrestrial antennas based on a distance between a predetermined location associated with the postal zipcode corresponding to the location of the one of the television receiving device and the at least one antenna device and a predetermined location associated with the postal zipcode corresponding to the location of the respective over-the-air terrestrial antenna for each of the plurality of over-the-air terrestrial antennas.

15. The device of claim 10, wherein the location information of the one of the television receiving device and the at least one antenna device comprises a latitude and a longitude corresponding to a location of the one of the television receiving device and the at least one antenna device, the location information of the plurality of over-the-air terrestrial antennas comprises, for each respective over-the-air terrestrial antenna of the plurality, a latitude and a longitude corresponding to a location of the respective over-the-air terrestrial antenna, and the processor is configured to determine the select over-the-air terrestrial antennas of the plurality of over-the-air terrestrial antennas based on a distance between the latitude and longitude corresponding to the location of the one of the television receiving device and the at least one antenna device and the latitude and longitude corresponding to the location of the respective over-the-air terrestrial antenna for each of the plurality of over-the-air terrestrial antennas.

16. The system of claim 15, wherein the processor is configured to receive the location information of the one of the television receiving device and the at least one antenna device as a street address defining the location of the one of the television receiving device and the at least one antenna device, and to convert the street address into the latitude and longitude corresponding to the location of the one of the television receiving device and the at least one antenna device.

17. A method for setup of a device for receiving over-the-air television signals from over-the-air terrestrial antennas, the method comprising:
determining location information of the device;
determining location information of a plurality of over-the-air terrestrial antennas;
determining a subset of the plurality of over-the-air terrestrial antennas based on the determined location information of the device and the determined location information of the plurality of over-the-air terrestrial antennas; and
setting the device to receive over-the-air television signals from at least part of the subset of over-the-air terrestrial antennas based at least in part on a strength of over-the-air television signals received at the device from the subset of the plurality of over-the-air terrestrial antennas.

18. The method of claim 17, further comprising determining the strength of over-the-air television signals received at the device from the subset of the plurality of over-the-air terrestrial antennas by scanning only for frequencies at which over-the-air terrestrial antennas of the subset transmit over-the-air terrestrial television signals.

19. The method of claim 18, further comprising:
determining a heading for each of the over-the-air terrestrial antennas of the subset; and
scanning for the frequency of each of the over-the-air terrestrial antennas of the subset only along the determined heading for the respective over-the-air terrestrial antennas of the subset.

20. The method of claim 17, wherein determining the subset of the plurality of over-the-air terrestrial antennas is based on a distance between the device and each of the plurality of over-the-air terrestrial antennas.
